(19) United States
(12) Patent Application Publication
(10) Pub. No.: US 2006/0218245 A1
(43) Pub. Date: Sep. 28, 2006

(54) Method, system, and computer program product for distributing a stored URL and web document set

(76) Inventor: Frederic A. Horn, Escondido, CA (US)

Correspondence Address: Roy L. Anderson, Esq..;LAW OFFICES OF JOHN E. WAGNER, 3541 Ocean View Boulevard, Glendale, CA, 91208, US

(21) Appl. No.: 11/417,037

(22) Filed: May 2, 2006

Related U.S. Application Data
(62) Division of application No. 10/124,321, filed on Apr. 17, 2002.
(60) Provisional application No. 60/300,005, filed on Jun. 21, 2001.
(60) Provisional application No. 60/310,154, filed on Aug. 3, 2001.
(60) Provisional application No. 60/324,881, filed on Sep. 25, 2001.
(60) Provisional application No. 60/327,242, filed on Oct. 5, 2001.
(60) Provisional application No. 60/340,771, filed on Oct. 30, 2001.

(51) Int. Cl. G06F 15/16

(52) U.S. Cl. 709/218

(57) ABSTRACT

A method, system and computer program for distributing a stored URL and web document set. The set includes data file records that contain a stored URL and the web document associated with the stored URL. The set is stored on a first computer system. In a specific embodiment, the set is stored in eXtensible Markup Language. When a query request is submitted, data file records are selected and a second set of data file records is created. The second set of data file records is sent to a second computer system.

### REFERENCE TO RELATED APPLICATIONS

This divisional patent applications claims priority from U.S. non-provisional patent application Ser. No. 10/124,321 filed Apr. 17, 2002, which claims priority from U.S. provisional patent application Ser. No. 60/300,005, filed Jun. 21, 2001, Ser. No. 60/310,154, filed Aug. 3, 2001, Ser. No. 60/324,881, filed Sep. 25, 2001, Ser. No. 60/327,242, filed Oct. 5, 2001, and Ser. No. 60/340,771, filed Oct. 30, 2001, the disclosures all of which are specifically incorporated herein by reference, and hereby claims the benefit of the embodiments therein and of the filing dates thereof.

### BACKGROUND OF THE INVENTION

1. Field of the Invention

This invention relates to the field of information provider and information access apparatus, such as World Wide Web (WWW) Server and Browser applications executing on a computer. Specifically, this invention is a new and useful method, system, and computer program product for distributing a set of stored URL and web document sets.

2. Description of Related Art

The World Wide Web (“Web”) is a massive collection of Web pages that are linked together by the Internet, the world's largest public network. Using the Web and the Internet, a user has access to a wealth of diverse and poorly organized information at his fingertips. The Internet also provides an economical method for sharing information and resources. For example, computer programs may be operated in a vacuum with the executable code and the data stored in one computer system, or through a combination of different computers. Thus, portions of the present invention may reside on one computer system, while other portions reside on a second computer. For example, the executable portions may reside on and be processed by a client, while a server stores the data and manages access to the data.

The Web has also led to the proliferation of the Application Service Provider (ASP) environment, whereby a service provider provides applications on a server, and the applications are accessed by the user's client through the Internet or other network. A similar model is a hosted, Wireless Application Service Provider (W-ASP) mode. ASP and W-ASP applications permit the “download” of data that is selected and stored by the administrator of the server onto a local client device, such as a personal computer, cell phone, handheld PC or PDA, tablet PC, television set top box or game console.

A “Web page” (also referred to by some designers simply as a “page” or a “document”) is a data file written in a hyper-text language, such as Hypertext Markup Language (HTML), that may have text, graphic images, and even multimedia objects, such as sound recordings or moving video clips associated with that data file. A Web page contains control tags and data. The control tags identify the structure; for example, the headings, subheadings, paragraphs, lists, and embedding of images. The data consists of the contents, such as text or multimedia that will be displayed or played to the user.

The primary software used on client machines for connecting to and displaying Web pages is called a Web browser. The main function of a Web browser is to interpret the information received from a Web page and display it on a computer monitor. Existing web browsers such as Microsoft Internet Explorer, Netscape Navigator, and Opera include a feature for collecting stored Universal Resource Locators (URL's) in the form of “Favorites,” “bookmarks,” “Favorite Places,” or other names. These stored URLs are comprised of the actual URL and a textual description of the URL. The next time the user wants to connect to his favorite Web page, he selects the stored URL from the stored URL list without having to remember or type in the address. Thus, the stored URL feature gives the user a quick way of connecting to his favorite Web page. Many browsers also include a “history” list, which is a list of addresses of recently visited Web Pages.

The typical stored URL software feature stores a single URL saved by name as described in the meta-tag HTML data of the web site author. One problem for the user is difference between the actual HTML content of the web page and web site at the URL, and the name provided by the web site author. In many cases, web page authors do not accurately portray the content of their web pages. Searching a stored URL list is also difficult. Search tools in prior art web browser applications such as Netscape only search the name descriptions provided by the web author and therefore produce the inefficient, ineffective overall results for the user.

Once created, stored URLs offer a convenient means of page retrieval. The user can cause the browser to display his stored URL list and select among his stored URLs to go directly to a favorite page. Despite their usefulness, the current implementations of stored URL lists are not without their flaws. As the numbers of web sites and web sites have increased dramatically, so has the number of stored URLs that a typical user maintains on his browser. It is not uncommon that hundreds of stored URLs are stored in a stored URL list. Existing browsers allow for organization of stored URLs into folders or directories. The folders and their contents can be copied and moved to other locations within the stored URL list. However, there is no ability within a stored URL list to query on the stored URLs and subsequently move or copy the resulting aggregate collection of stored URLs to a user-designated folder.

Another problem with retrieving information on the Internet is the amount of time required to sift through the enormous amount of information available to find the relatively few web pages or files of interest. Search engines help to a degree, but the results of a search often include far more Web pages than desired. A substantial amount of user time is required to refine search strategies, compile, and discard results and so forth. Thus, a good list of stored URLs on a given topic can represent a significant investment in time and effort. Presuming that the topic is of interest to others as well, the list of stored URLs is a valuable commodity which others would be interested in sharing.

While functionality exists to search the stored URLs included in a stored URL list for a keyword or phrase, only the textual description of the stored URL list is compared to the search criteria and only one web browser's Favorites list is compared to the search criteria. The content of the web document associated with each stored URL is not compared to the search criteria. Users may search a browser's history list in Internet Explorer for a keyword or phrase, and the search may include the web document content associated with the historical stored URL. However, a user cannot simultaneously search web document content of two URL lists. In addition, search results may not be added to the browser's stored URL list in aggregate.

A further problem with searching for information on the Internet is that historical query parameters are not stored and cannot be displayed in a ranking order as determined by the frequency of usage. Further, users are not notified of changes to the web document content associated with stored URLs in a stored URL list or that web document content is no longer associated with a given stored URL. Because the web document content is not stored, the data is not updated.

Existing browsers feature “send link by email” or “send page by email.” This feature only sends the document that is currently displayed in the web browser or the currently selected stored URL. Multiple URL's can be sent only by using the Windows cut and paste functions.

The exponential growth of web-browser users and available digital content worldwide over the Internet creates an increasing demand for software applications that can access the Internet, Intranet, Extranet and Virtual Private Network and provide content processing and URL data processing which also maintains Internet and World Wide Web standards and protocols. The universal and worldwide popularity of the World Wide Web has propelled the development beyond SGML and HTML to other program languages and protocols for creating and sharing digital content “web pages”, including Dynamic Hyper-Text Markup Language (dHTML), XHTML, Java, JavaScript, Active X, Flash, Virtual Reality Modeling Language (VRML), extensible Markup Language (XML), Simple Object Access Protocol (SOAP) and Universal Description, Discovery and Integration (UDDI).

In conjunction with the new program languages and protocols as outlined above, related art web browser enhancement technologies have been commonly utilized by web browser users. “Helper Applications” such as Zip compressed file utility programs, “Java applets,” and “Plug-In Applications” such as RealNetworks, RealPlayer, Microsoft Windows Media Player, Silicon Graphics WebSpace VRML browser, and Macromedia Flash Player, enhance the web browser content experience. However, these enhancement technologies do not enhance the functionality and features of stored URL data processing for the user within the most popular web browser art of Microsoft Internet Explorer, Netscape Communications Navigator, and Opera. Thus, a need exists for a method, system and computer program product that addresses the problems and shortcomings associated with current web browser technology, specifically in the manual data processing functions of the prior art stored URL functionality.

As used herein, certain terms are defined as set forth below:
Browser: A browser is a software program that allows you to view and interact with various kinds of Internet resources available on the World Wide Web. A browser is commonly called a web browser.
Folder/Directory: An organizational feature of most software systems.

Electronic documents, files, URLs, etc. are stored within. Usually, files of a like nature are stored within a particular folder (i.e.; system files for the Windows Operating System are stored in the Windows folder).
Hard Disk: A magnetic disk on which store computer data can be stored.
History File: A collection of recently viewed web page URLs saved in a web browser.
HTML: Acronym for Hyper Text Mark Up Language, which is the common language used for the World Wide Web. HTML is an application of SGML that uses tags to mark elements, such as text and graphics, in a document to indicate how Web browsers should display these elements to the user and should respond to user actions, such as activation of a link by a mouse click.
I-DVD Player: A device that interactively utilizes Digital Versatile Disc and other optical disc media technology (such as VCD (Video Compact Disc)) through a video interface (i.e.; television). For the purposes of this document, Interactive DVD pertains to Internet Web-Browser enabled DVD devices.
I-Game Console: A Game Console that incorporates Internet connectivity through a web browser.
I-GPS (Global Positioning System) Device: A web-browser enabled device that provides specially coded satellite signals that can be processed in a GPS receiver, enabling the receiver to compute position, velocity and time. Four GPS satellite signals are used to compute positions in three dimensions and the time offset in the receiver clock. A GPS Web-Browser Enabled device uses GPS technology to access the World Wide Web.
I-Set-Top Box: A device that enables a television set to become a user interface to the Internet using web browser-enabled software, and enables a television set to receive and decode digital television broadcasts. The device may have digital recording functionality with a hard drive mechanism to store programming.
I-Tablet Computer: A slate-like computer utilizing a pen-based input that can function as a sheet of paper and that incorporates Internet connectivity through a web browser.
Internet: The large system of many connected computers around the world that people use to communicate with each other. Example: I heard about the new development on the Internet.
Keywords/Keyphrases: In this document, a word, collection of words, or particular phrase that will be compared to other textual content. Example: Search for keywords “Hospital,” “Medical,” “Doctors.” Search for keyphrase “San Gabriel Hospital”
Link: Refers to any highlighted words or phrases in a hypertext document that allow you to jump to another section of the same document or to another document on the World Wide Web.
Meta Tags: A tag used in the header of a web document page to provide information about the page. There may be multiple Meta tags in a header, each with different information. In current usage, each tag includes the name of the information and the content that supports that name. Example: <meta name=“title” content=“Emily Dickinson Home Page”>. Other commonly used meta tag names are description, keywords, date, and copyright.
Memory: The term memory identifies data storage that comes in the form of chips (A small piece of semi conducting material (usually silicon) on which an integrated circuit is embedded). This technology is used as primary or main data store for devices such as Personal Digital Assistants and Pocket PC's.
Server: A server is a computer that handles requests for data, e-mail, file transfers, and other network services from other computers.
SGML: Acronym for Standard Generalized Markup Language. An information management standard as a means of providing platform and application independent documents for formatting, indexing, and linked information with a grammar-type mechanism.
Stored URL: A Uniform Resource Locator, or resource web address, stored by a web browser. Other names for stored URLs include “Favorites,”
“Bookmarks,” and “Favorite Places.”
Stored URL list: A collection of stored URLs.
URL: Acronym for Uniform Resource Locator. An address for a resource on the Internet. URLs are used by web browsers to access Internet resources. A URL specifies the protocol to be used in accessing the resource (such as “http:” for a World Wide Web page, or “ftp:” for a FTP site), the name of the server on which the resource resides, and, optionally, the path to a resource. URLs are also known as URIs, or Uniform Resource Identifiers.
Web Page/Website: A web page is a document created with HTML (Hypertext Markup Language) that is part of a group of hypertext documents or resources available on the World Wide Web. Collectively, these documents and resources form what is known as a Website. Users can read HTML documents that reside somewhere on the Internet or on a local hard drive with a software program called a web browser. Web browsers read HTML documents and display them as formatted presentations, with any associated graphics, sound, and video, on a computer screen. Web pages can contain hypertext links to other places within the same document, to other documents at the same website, or to documents at other websites. They can also contain fill-in forms, photos, large clickable images, sounds, and videos for downloading.
World Wide Web: The system of connected documents on the Internet, which often contain color pictures, video and sound, and can be searched for information about a particular subject.
XML: Acronym for extensible Markup Language, a markup language that is an application profile, or subset, of SGML. XML documents are composed of markup and content. There are six kinds of markup that can occur in an XML document: elements, entity references, comments, processing instructions, marked sections, and document-type declarations. XML is a markup language for documents containing structured information. An “XML document” refers to text and other XML “data formats,” including vector graphics, e-commerce transactions, mathematical equations, object meta-data, server APIS, and other structured information.

### BRIEF SUMMARY OF THE INVENTION

The present invention provides a method, system and computer program product for distributing a stored URL and web document set. More specifically, the present invention creates a data file containing a plurality of data file records, each data file record containing a stored URL and the web document associated with the stored URL, stores the data file on a first computer system, and responsive to a request for selecting data file records, creates a stored URL and web document set of the selected data file records. The stored URL and web document set may be sent as a unit to a second computer system.

In a more detailed aspect, the present invention provides for searching of the data file records for records matching keywords or keyphrases (query parameters). A more specific detail of the invention improves the user's ability to search within XML URL data stored in web browser software files. The present invention thereby enhances the speed and access for the user to search data file records for keyword/key phrase content throughout all the web page content of the stored URLs, not only the URL title description. The matching records may be shared with satellite or secondary devices. Alternatively, the matching records may be organized into folders within a browser designated by the user. The present invention further discloses ranking of searches to count the number of times a given group of query parameters have been searched.

Another aspect of the invention discloses a method, system, and computer program product for collecting new web documents matching the keywords or keyphrases from the Internet. Similarly, the present invention also includes a mechanism for updating existing data file records to such that the web document portion of the data file record matches the web document on the Internet corresponding to the stored URL portion of the data file record.

Yet another aspect of the invention discloses a mechanism for synchronizing the data file of one device with the data file of another device. This aspect provides that the most current data file record from the two data files is written to the other file. Data records not found in one data file are copied to the other file.

The invention also discloses a method, system and computer program product for reminding the user to visit selected web pages on a user-selected basis. A more detailed aspect of the invention provides a mechanism for the user to modify reminders individually or as a group.

The present invention utilizes extensible Markup Language (XML), or other programming languages, in a method, system and computer program product, to allow the user to share data file records within a client, among any web browser enabled devices, and throughout various distributed computing systems, including Internet, Intranet, Extranet and Virtual Private Network networks. The invention also provides an improved method, system and computer product for sharing individual or collections of data file records with other Internet/intranet users and sharing data formatted in XML to world-wide-web data servers. Accordingly, the invention enhances the speed and access for the web browser software user to share data file records with other users on any web browser enabled device.

Similarly, the invention provides an improved method, system and computer product, for retrieving and storing individual or collections of data file records shared by other Internet/Intranet users. Thus, the present invention enhances the speed and access for a user to retrieve and store data file records from other users in messages sent via E-Mail, Instant Message or Peer-to-Peer communication.

Detailed aspects of the invention store URL (Universal Resource Locator) address data, URL meta-tag data and URL Hyper-Text Markup Language (HTML) content data, as well as all other content included in web pages, as data file records in an eXtensible Markup Language (XML) data structure within web browser stored URL software files. Thus, web browser stored URLs and their associated content, meta-data and HTML content are stored in an XML data structure format. The user is then provided with the ability to XML query the stored data file records for keywords/key phrases. The detailed invention shares individual or collections of data file records as an XML document through Instant Messaging client, email and/or network directory. Finally, the stored data is continuously updated when connected to the World Wide Web with a web browser and the invention will reflect any changes in a URL's actual meta-data and HTML content by storing an updated data file record.

These and additional features and advantages of the present invention will become more apparent from the detailed description set forth below when taken in conjunction with the drawings in which like reference characters generally identify corresponding elements throughout. Further, while described specifically with regard to one computer system, the functions and methods described below are applicable to both primary devices on which the present invention may be installed, and secondary “satellite” devices. Similarly, the executable portions of the present invention may reside on and be processed by a client, while a server stores the data and manages access to the data.

In an alternative, the invention may be operated in an ASP environment or W-ASP environment and accessed by the user's client through the Internet or other network. The ASP or W-ASP applications permit the “download” of sets of data file records selected and stored by the administrator of the server. In this implementation, the Internet consumers, intranet employees, extranet customers may download the stored data file record sets offered by the administrator directly onto a local client device such as a personal computer, cell phone, handheld PC or PDA, tablet PC, television set top box or game console.

Additionally, although described with regard to user-initiated functions, in many cases the “user” may itself be a computer program designed to automatically execute certain functions, such as the update and synchronize functions described in detail below. Further, the present invention may be provided by one user to another user. In this manner, the first user may provide a preloaded data file to the second user as software that is preinstalled on a client device, or software that is stored on a CD-ROM, CD, DVD, Web site download or other recordable media, ready for launch and installation by the second user.

### BRIEF DESCRIPTION OF THE DRAWINGS

The accompanying drawings, which are incorporated herein and form part of the specification, illustrate embodiments of the present invention and, together with the description, further serve to explain the principles of embodiments of the invention.

FIG. 1 illustrates example screen shot for selecting a default browser according to an embodiment of the invention;

FIG. 2 illustrates example screen shot for selecting additional browsers according to an embodiment of the invention;

FIG. 3 illustrates example screen shot for selecting search engines according to an embodiment of the invention;

FIG. 4 illustrates example screen shot for selecting an email application according to an embodiment of the invention;

FIG. 5 illustrates example screen shot for selecting instant messengers according to an embodiment of the invention;

FIG. 6 illustrates example screen shot for selecting a web site, FTP address, login, password, and directory for sharing data file records according to an embodiment of the invention;

FIG. 7 illustrates example screen shot for selecting a shared network folder for sharing data file records according to an embodiment of the invention;

FIG. 8 illustrates example screen shot for selecting devices and a shared network folder with which data file records will be synchronized according to an embodiment of the invention;

FIG. 9 illustrates example screen shot for confirming the user's selections (as entered through FIGS. 1 through 8) according to an embodiment of the invention;

FIG. 10 illustrates example screen shot for operation of function Home Form according to an embodiment of the invention;

FIG. 11 illustrates example screen shot for operation of function History according to an embodiment of the invention;

FIG. 12 illustrates example screen shot for operation of function Search according to an embodiment of the invention;

FIG. 13 illustrates example screen shot for operation of function Add New (Collect) according to an embodiment of the invention;

FIG. 14 illustrates example screen shot for operation of function Send (Share) according to an embodiment of the invention;

FIG. 15 illustrates example screen shot for operation of function Organize according to an embodiment of the invention;

FIG. 16 illustrates example screen shot for operation of function Update according to an embodiment of the invention;

FIG. 17 illustrates example screen shot for operation of function Rank according to an embodiment of the invention;

FIG. 18 illustrates example screen shot for operation of function Synchronize according to an embodiment of the invention;

FIG. 19 illustrates example screen shot for operation of function Remind according to an embodiment of the invention;

FIG. 20 illustrates example screen shot for operation of function Reminders according to an embodiment of the invention;

FIG. 21 illustrates example screen shot for operation of function OneStep according to an embodiment of the invention;

FIG. 22 is a block diagram of primary devices, secondary devices and certain functions according to an embodiment of the invention;

FIG. 23 is an example flowchart of a process for storing web documents according to an embodiment of the invention;

FIG. 24 is an example flowchart of a process for searching for keywords or keyphrases among data file records according to an embodiment of the invention;

FIG. 25 is an example flowchart of a process for collecting and storing web documents containing keywords or keyphrases according to an embodiment of the invention;

FIG. 26 is an example flowchart of a process for sending or sharing data file records according to an embodiment of the invention;

FIG. 27 is an example flowchart of a process for organizing data file records within browsers according to an embodiment of the invention;

FIG. 28 is an example flowchart of a process for comparing and updating stored data file records with web documents according to an embodiment of the invention;

FIG. 29 is an example flowchart of a process for ranking searches by frequency of use according to an embodiment of the invention;

FIG. 30 is an example flowchart of a process for synchronizing data files between two sources according to an embodiment of the invention; and

FIG. 31 is an example flowchart of a process for combining store, update, synchronization, search, collect, share and organize processes according to an embodiment of the invention.

It should be understood that these figures depict embodiments of the invention. Variations of these embodiments will be apparent to persons skilled in the relevant art(s) based on the teachings contained herein. For example, the flow charts contained in these figures depict particular operational flows. However, the functions and steps contained in these flow charts can be performed in other sequences, as will be apparent to persons skilled in the relevant art(s) based on the teachings contained herein.

### DETAILED DESCRIPTION

1. Primary Device Method Description

1.1 Method Setup—User Parameter Collection

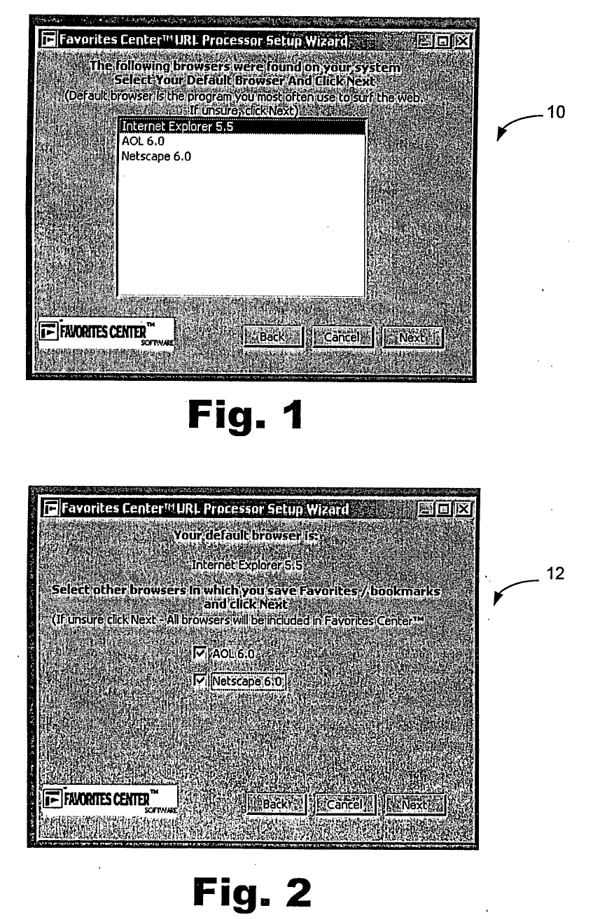

The examples set forth with regard to FIGS. 1 through 9 are the preferred initial setup procedure for the present invention and are referenced collectively as the User Parameter Collection functions. In the preferred embodiment, information is collected from the user and stored in a Parameter XML data file record, one of the records included in an XML data file. The initial storing of stored URLs and their relative web document content is performed at the conclusion of this setup procedure. This information is then used within the update, search, add new (collect), send (share), move/copy (organize) and rank functions.

1.1.1 Default Browser

FIG. 1 sets forth an example screen shot for the process for selecting a default browser, function Default Browser 10. The default browser will be used to store URL collections (stored URLs) that result from the search and collect functions. A new folder will be created within the stored URL feature of the default browser and named accordingly (i.e.; searches for “Mozart” on Jun. 1, 2001 will be stored in a new folder named “Mozart Favorites Jun. 1, 2001;” collection procedure results will be stored in a new folder named “New Mozart Favorites”).

1.1.2 Additional Browsers

The user may select additional browsers for which the present invention will store, search, send, organize, and update stored URLs through function Additional Browsers 12 (FIG. 2). In the screen shot example set forth in FIG. 2, web document content will be stored for all stored URLs existing in the AOL 6.0 and Netscape 6.0 browsers as well as those stored URLs existing in the default browser.

1.1.3 Search Engines

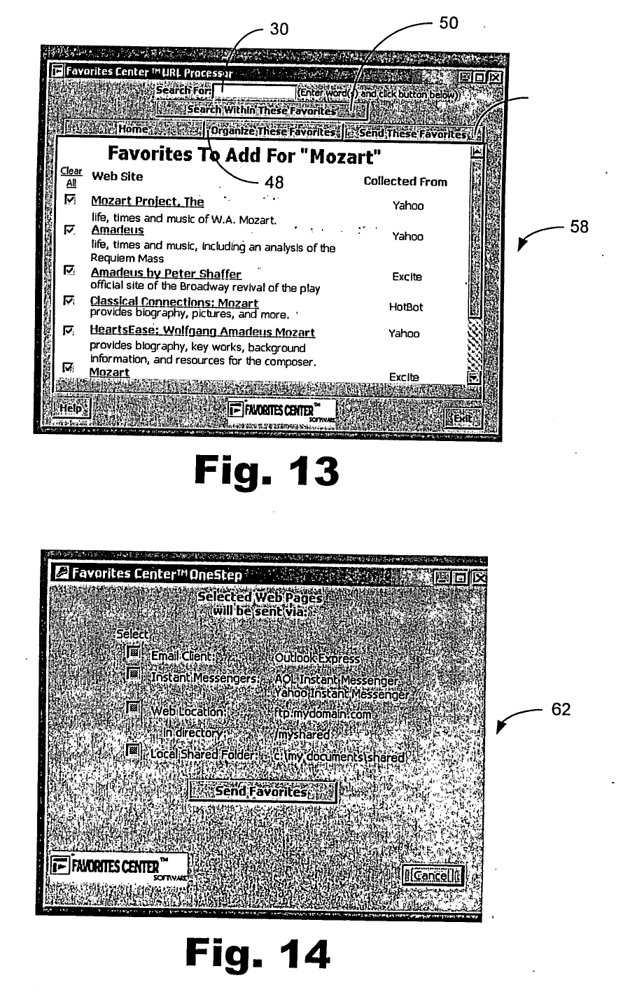

As illustrated in FIG. 3, in function Search Engines 14, the user may select search engines to which function Add New (Collect) 58 (described below, FIG. 13) will submit keywords by default. Results are returned as per the OneStep and Add New functions in function OneStep 100 (also described below, FIG. 21) and function Add New (Collect).

1.1.4 Email Client

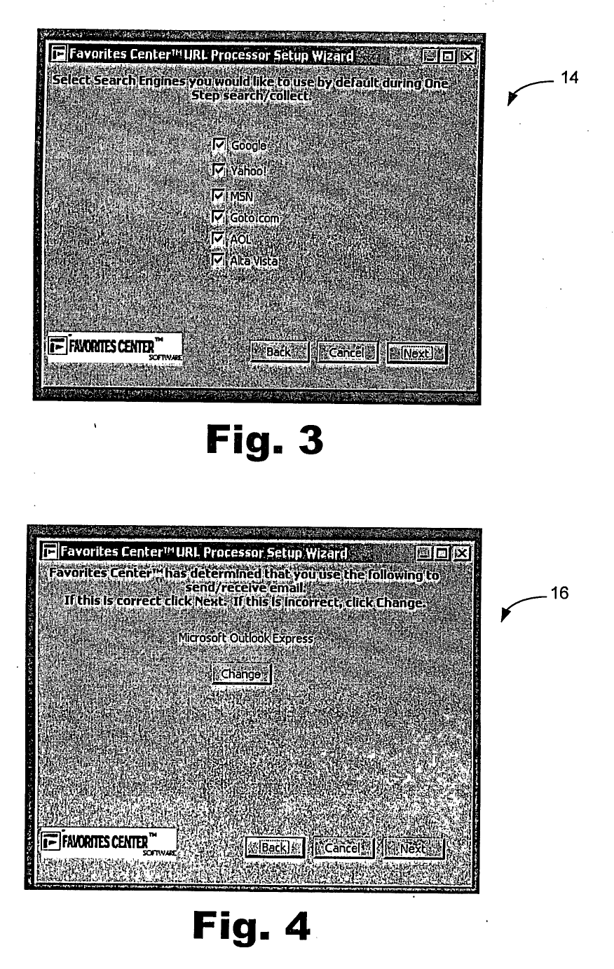

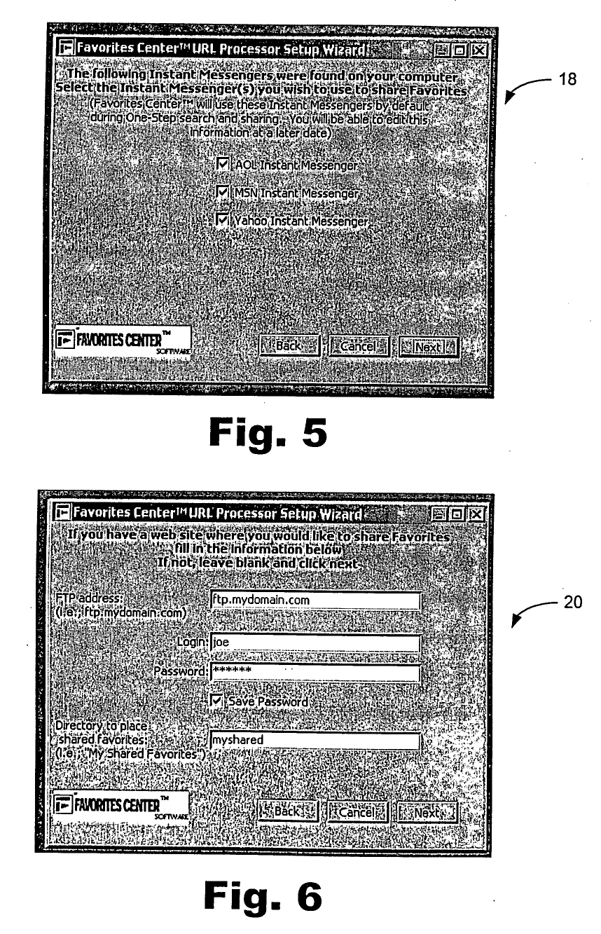

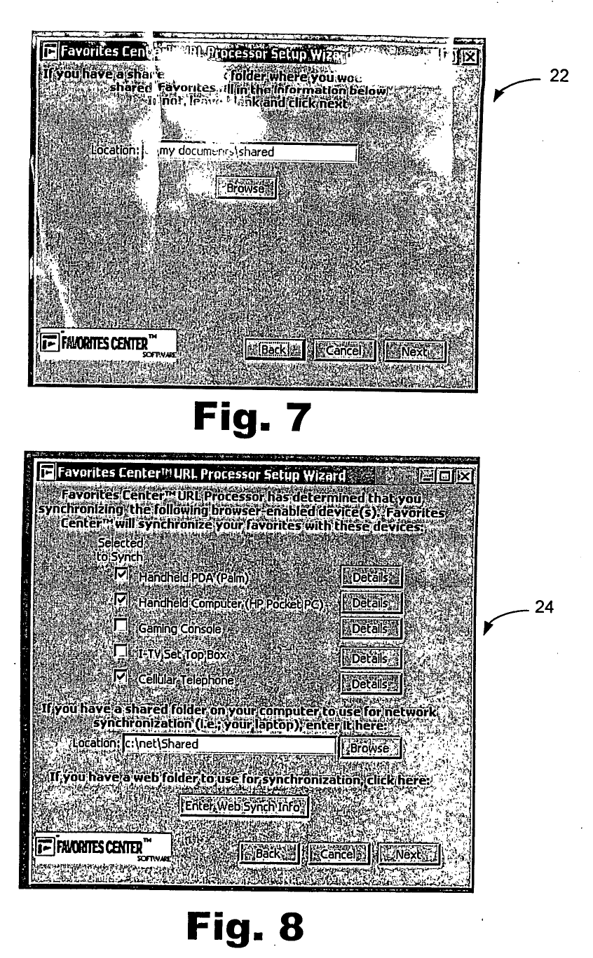

FIG. 4 sets forth function Email Client 16 for the user to confirm the email client that will be used to share collections of stored URLs.

1.1.5 Instant Messaging Clients

As shown in FIG. 5, using function Instant Messaging Clients 18, the user may select Instant Messenger clients to be used by default in sharing collections of Favorites stored URLs.

1.1.6 Web Sharing Information

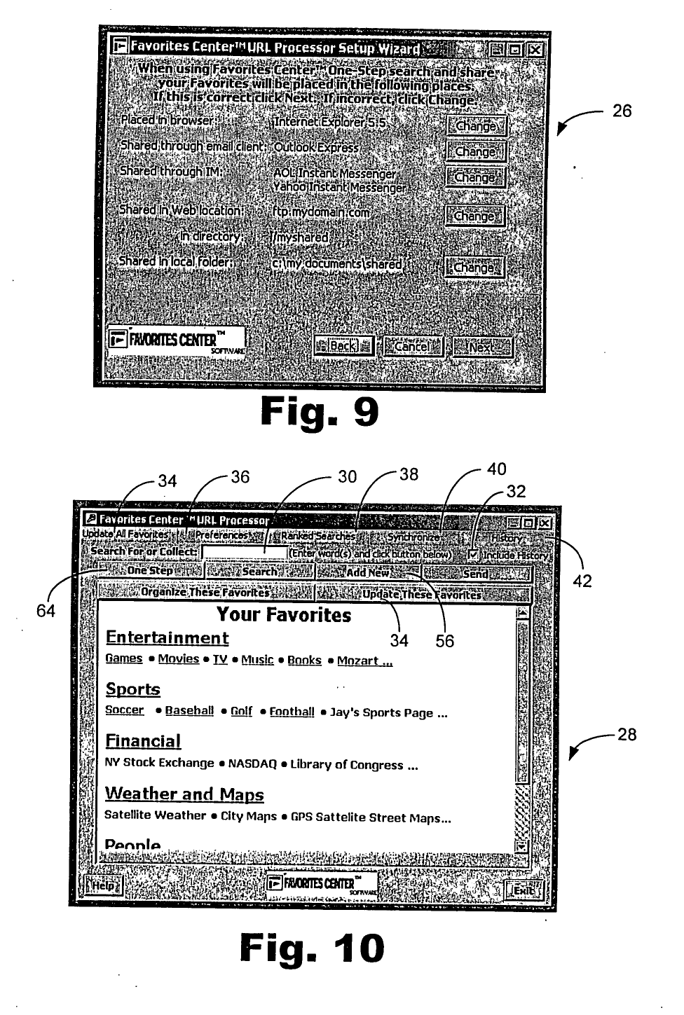

In FIG. 6, the user accesses function Web Sharing Information 20 to enter the File Transfer Protocol address at which collections of stored URLs will be placed in viewable XML format during the share function. This address can then be forwarded to (shared) with Internet users.

1.1.7 Network Folder

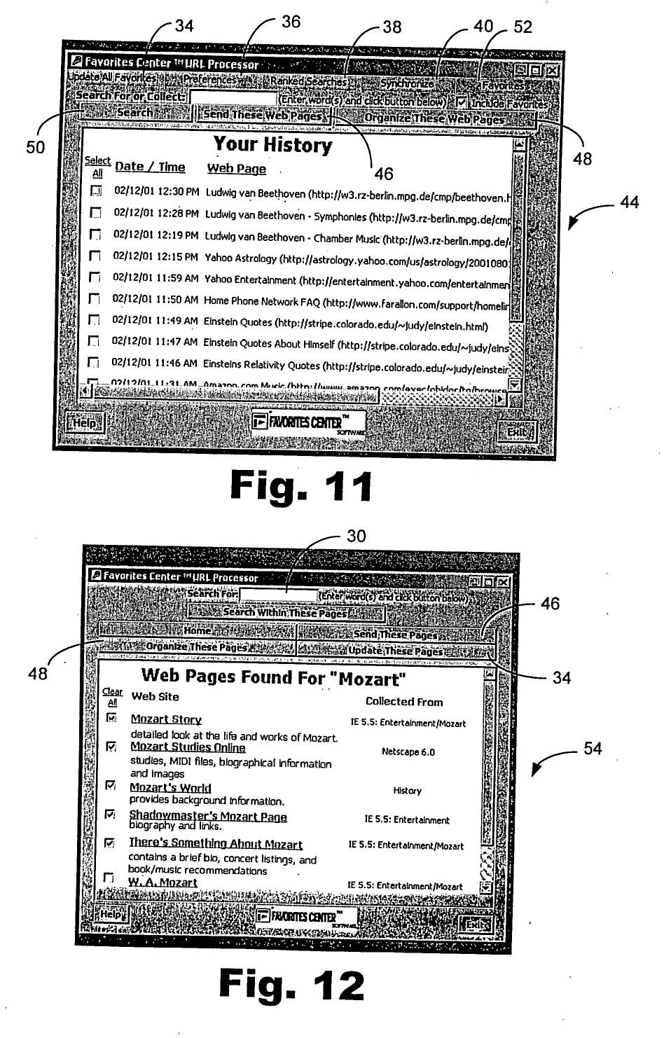

FIG. 7 sets forth a process in function Network Folder 22 for designating the local shared network folder in which collections of stored URLs will be placed in viewable XML format during the share function.

1.1.8 Synchronization Devices

As illustrated in FIG. 8, using function Synchronization Devices 24, mobile devices are selected for synchronization of the XML data file. The file will be transferred to the mobile device during the synchronization function. A shared folder may be selected for synchronization of devices that access the user's network (i.e., laptop computers).

1.1.9 Confirmation

A screen shot illustrating a function Confirmation 26 for confirmation of preferences selected by the user in previous setup sections 1.1.1 through 1.1.8 is illustrated in FIG. 9. Upon confirmation, as described in more detail below, the method will store Favorite descriptions and URL's (stored URLs) for selected browsers in XML records in the XML data file. Relative web documents for each Favorite stored URL will be accessed and stored within the XML data file record.

The OneStep function 100 as described below (FIG. 21) may optionally be performed with all data file records in the XML data file (i.e., all saved stored URLs will be shared via the user-designated parameters). Upon completion of the confirmation process, the user will be presented with the primary operational function, function Home Form 28 (FIG. 10).

1.2 User Operation

1.2.1 Home Form

The form set forth in FIG. 10 is an example screen shot for the function Home Form 28. This form displays to the user all the user's stored URLs in “directory” format. Folders within stored URL software are designated with an underlined font. URL's are designated with a normal (not underlined) font. All text is hyperlink. The user may click on Favorite folders to display the contents of that folder within the form of FIG. 10. If the hyperlink designates a URL, the user's default browser is opened and addressed to that URL.

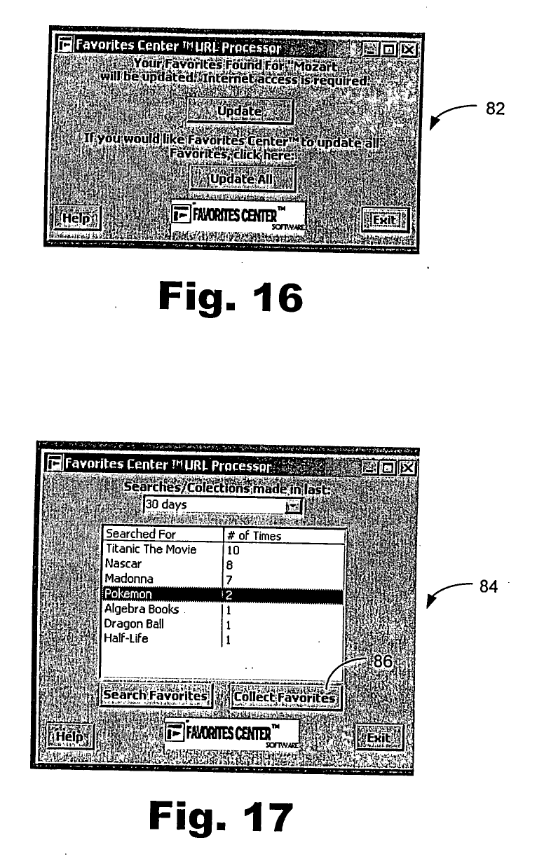

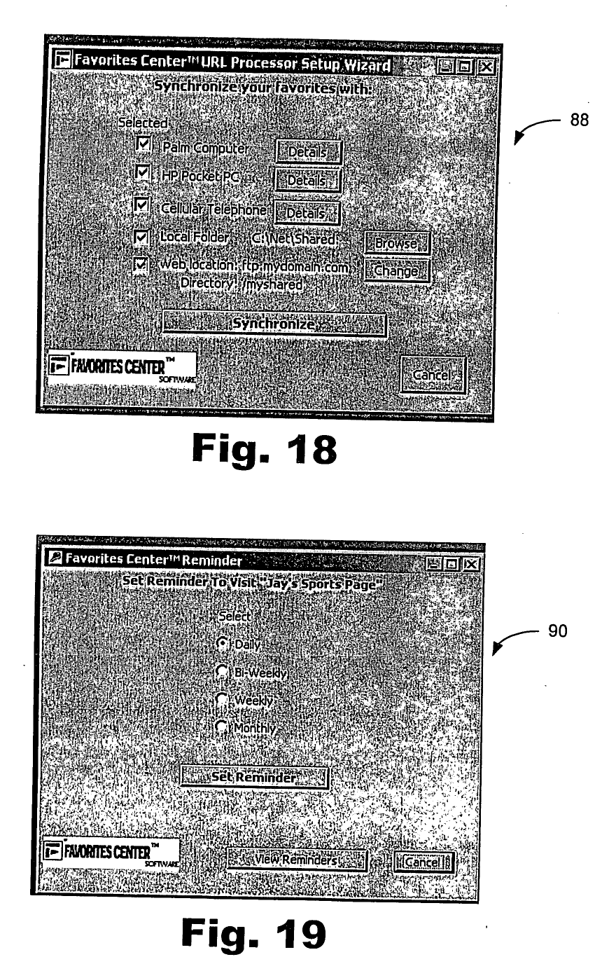

Keywords for searching among the user's stored URLs are entered in the “Search for or Collect” text box 30. If an Include History button 32 is selected, Favorite stored URLs and History stored URLs will be included in the query. The remaining buttons shown in FIG. 10 designate functions to be performed with the keyword parameters. Selection of the Update All Favorites button 34 results in the operation of function Update 82 described below (FIG. 16). Selection of the Preferences button 36 results in the operation of the User Parameter Collection functions as described in sections 1.1.1 through 1.1.9 allowing the user to change default preferences. Selection of the Ranked Searches button 38 results in the operation of function Rank 84 below (FIG. 17). Selection of the Synchronize button 40 results in the operation of function Synchronize 88 (FIG. 18). Selection of the History button 42 results in the operation of function History 44 (FIG. 11). Lastly, right clicking on a URL in the “directory” window results in a sub-menu with an option to operate the function Remind 90 below (FIG. 19).

1.2.2 History

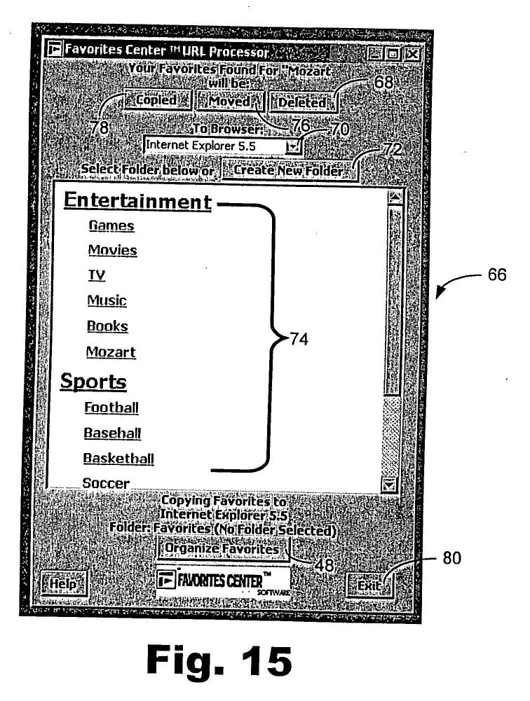

When the Include History button 32 is selected from function Home Form 28 (FIG. 10), operation of the function History 44 as set forth in the form of FIG. 11 is the result. The form displays browser History stored URLs by date visited. The user may select individual or all stored URLs previously visited. Once selected, the user may select one of the following buttons: (a) a Send These Web Pages button 46 to send the selected stored URLs and associated web pages in accordance with function Send (Share) 62 (FIG. 14); (b) an Organize These Web Pages button 48 to organize the selected URL's as per function Organize 66 (FIG. 15); and (c) a Search button 50 to search all historical URL's for a keyword/keyphrase as per function Search 54 (FIG. 12), optionally including saved stored URLs.

The selection of the Update All Favorites button 34 from FIG. 11 results in the operation of function Update 82 described below (FIG. 16). The Preferences button 36 results in the operation of the User Parameter Collection functions as described in sections 1.1.1 through 1.1.9 allowing the user to change default preferences. Selection of the Ranked Searches button 38 results in operation of the function Rank 84 below (FIG. 17), and selection of the Synchronize button 40 results in the operation of the function Synchronize 88 (FIG. 18). Lastly, selection of a Favorites button 52 returns the user to function Home Form 28 (FIG. 10).

1.2.3 Search

When the Search button 50 is selected from function Home Form 28 (FIG. 10), the present invention operates function Search 54 and compares keywords entered in the “Search for or Collect” text box 30 in FIG. 12 to stored URLs and web document content. Comparison is made to stored URLs stored in all browsers designated in the functions Default Browser 10 (FIG. 1) and Additional Browsers 12 (FIG. 2). Stored URLs that return a comparison of true are displayed as a collection as per FIG. 12.

Function Search 54 may be performed on the stored URLs displayed to further filter content. Keywords entered are compared to XML data file records for only the stored URLs in the displayed collection. The Add New function (function Add New (Collect) 58 (described below, FIG. 13) may be performed to retrieve additional URL's as per the Add New (Collect) function. In addition, the collection may be shared via Instant Messenger, Email, Network Folder, or web FTP by clicking on the Send These Pages button 46 using function Send (Share) 62, described below (FIG. 14). The collection may be moved or copied to a user-defined folder or deleted by clicking on the Organize These Pages button 48 using the function Organize 66 below (FIG. 15). Finally, the XML data file record for each Favorite stored URL in the collection may be updated by clicking the Update These Pages button 34 using the function Update 82 described below (FIG. 16).

1.2.4 Add New (Collect)

When an Add New button 56 is selected from function Home Form 28 (FIG. 10), as illustrated in FIG. 13, function Add New (Collect) 58 is initiated, and the present invention submits keywords entered in the “Search for or Collect” text box 30 to search engines selected within the function Search Engines 14 (FIG. 3). Stored URLs that return a comparison of true are displayed as a collection. The search function may be performed on the new stored URLs to further filter content by clicking on the Search Within These Favorites button 50. Keywords entered in FIG. 13 are compared to XML data file records for only the stored URLs in the displayed collection.

The collection or selected stored URLs within may be shared (by clicking the Send These Favorites button 46) via Instant Messenger, Email, Network Folder or web FTP as per function Send (Share) 62 described below (FIG. 14). The collection or selected stored URLs may be organized as per function Organize 66 below (FIG. 15) when the Organize these Favorites button 48 is chosen. Selecting a Home button 60 returns the user to function Home Form 28 (FIG. 10).

1.2.5 Send (Share)

Function Send (Share) 62, as illustrated in FIG. 14, is initiated when the Send button 46 is selected from function Home Form 28 (FIG. 10), function Search 54 (FIG. 12), function Add New (Collect) 58 (FIG. 13), or when a One Step button 64 is selected from function Home Form 28 (FIG. 10). Options are presented as per the user preferences entered selected through the User Parameter Collection functions described in sections 1.1.1 through 1.1.9. The user may select which portions of the Send function will be performed before sending stored URLs or cancel the procedure.

1.2.6 Organize

When the Organize button 48 is selected from function Home Form 28 (FIG. 10), function Organize 66 is initiated and the user is presented with the form shown in FIG. 15. If a Deleted button 68 is selected, a To Browser drop-down list 70, a Create New Folder button 72, a folder selection list 74 and the Organize Favorites button 48 are disabled. The user is presented with a dialog screen confirming deletion of selected stored URLs. If a Moved button 76 or a Copied button 78 are selected, the user selects the browser from the To Browser drop-down list in which the collection of stored URLs will be placed. The user may select an existing folder or create a new folder in which the collection of stored URLs will be placed (if the Moved button is selected, the stored URLs are deleted from the folder in which they originally reside). The Folder message (below the selection list) designates the selected folder in which stored URLs will be placed. Changes to location of the stored URLs will be reflected in the XML data file. The user may select an Exit button 80 to cancel the function.

1.2.7 Update

Function Update 82 (illustrated in FIG. 16) results when the Update button 34 is selected from function Home Form 28 (FIG. 10) or function Search 54 (FIG. 12). The Update function accesses the relative web documents designated by the URL for each Favorite stored URL in the collection. If the Update All Favorites button 34 is selected from function Home Form 28, web documents for all stored URLs in all browsers are accessed. Comparison of the web document data is made to the data stored in the XML data file. If the comparison is false (i.e.; the document has changed), the changes are reflected in the XML data file and the user is notified.

If no web document exists, the corresponding data file record for the Favorite stored URL is flagged as “Null.” The user may optionally: (a) delete the Favorite stored URL from the browser (and XML data file); (b) try to access the web document again; or (c) leave the Favorite stored URL (and XML data file record) as is (access to the web document will be attempted during the next Update function).

1.2.8 Rank

Function Rank 84 (illustrated in FIG. 17) results when the user selects the Ranked Searches button 38 from function Home Form 28 (FIG. 10). Query parameters are returned summarized by count (# of times searched) for the selected time period (i.e.; 30 days). When the user selects a query parameter from the list and clicks the Search Favorites button 50, the present invention searches existing stored URL data file records and displays result collection as per the function/form described in function Search 54 (FIG. 12). When the user selects a query parameter from the list and clicks a Collect Favorites button 86, the present invention performs function Add New (Collect) 58 for web pages matching the search criteria (FIG. 13).

1.2.9 Synchronize

Selecting the Synchronize button 40 from function Home Form 28 (FIG. 10) results in the initiation of function Synchronize 88 (illustrated in FIG. 18). The user may select devices with which Favorites stored URLs and web document data (XML file) will be synchronized. Options for synchronization are determined by the User Parameter Collection functions.

1.2.10 Remind

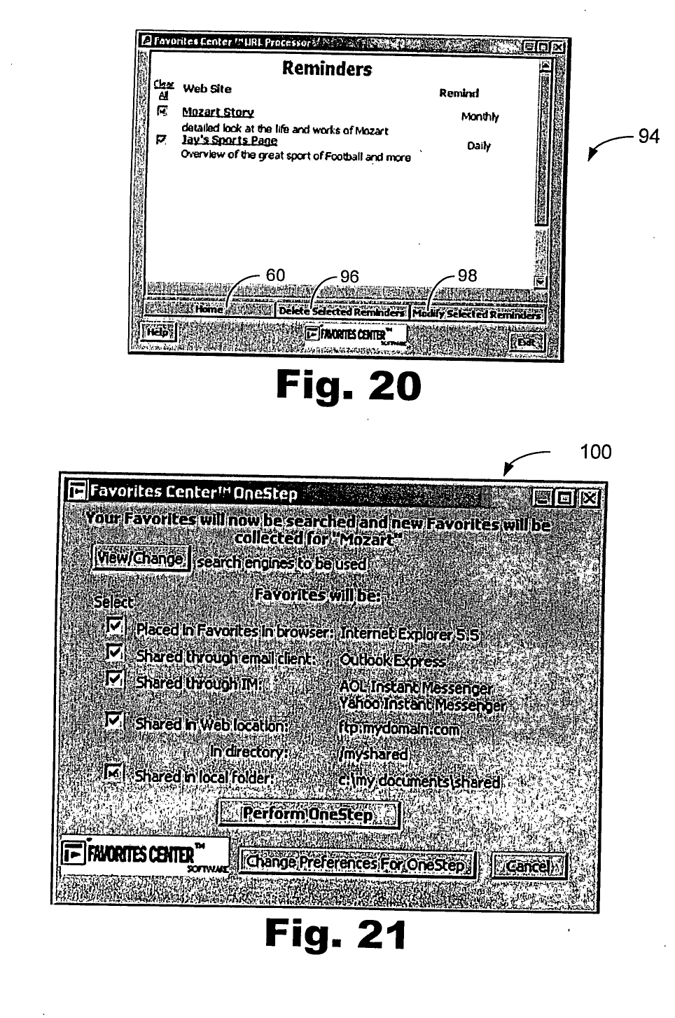

Selecting a Remind button from the sub-menu (not shown) of function Home Form 28 (FIG. 10) results in the start of function Remind 90 (illustrated in FIG. 19). The user may select the interval at which to be reminded to view the selected URL. Clicking a View Reminders button 92 results in the operation of function Reminders 94 (FIG. 20).

1.2.11 Reminders

If the View Reminders button 92 is selected from function Remind 90, the screen of FIG. 20 is the result and function Reminders 94 is activated. The user may select individual or multiple reminders and subsequently select from the following buttons:

(a) the Home button 60 to return to function Home Form 28 (FIG. 10), (b) a Delete Selected Reminders button 96 to remove reminders for selected URL's; or (c) a Modify Selected Reminders button 98 to adjust schedule for selected URL reminders (i.e.; change from Monthly to Weekly).

1.2.12 OneStep

Function OneStep 100 is activated when the OneStep button 64 (FIG. 10) is selected from function Home Form 28 (FIG. 10), and the form of FIG. 21 is presented to the user. This form displays OneStep preferences collected through the User Parameter Collection functions described in sections 1.1.1 through 1.1.9. The user may select the search engines to which the keyword(s) will be submitted, select which portions of the procedure will be performed, change preferences for the OneStep function, or cancel the function.

Function OneStep 100 includes the store, search, collect, share and organize and update functions (described in more detail below) in the following manner: (a) Search: Existing browser Favorites stored URLs are searched as per function Search 54; (b) Collect: URL's are collected as per the function Add New (Collect) 58; (c) Store/Update/Organize: Collections resulting from the function Search and function Add New (Collect) are placed (organized) in appropriate browser Favorites folders. Favorites descriptions, URL's and web document content are retrieved (i.e.; updated) and stored in the XML data file; and (d) Share: Collections are then shared as per the preferences outlined in function Send (Share) 62.

1.3 Functionality Diagrams

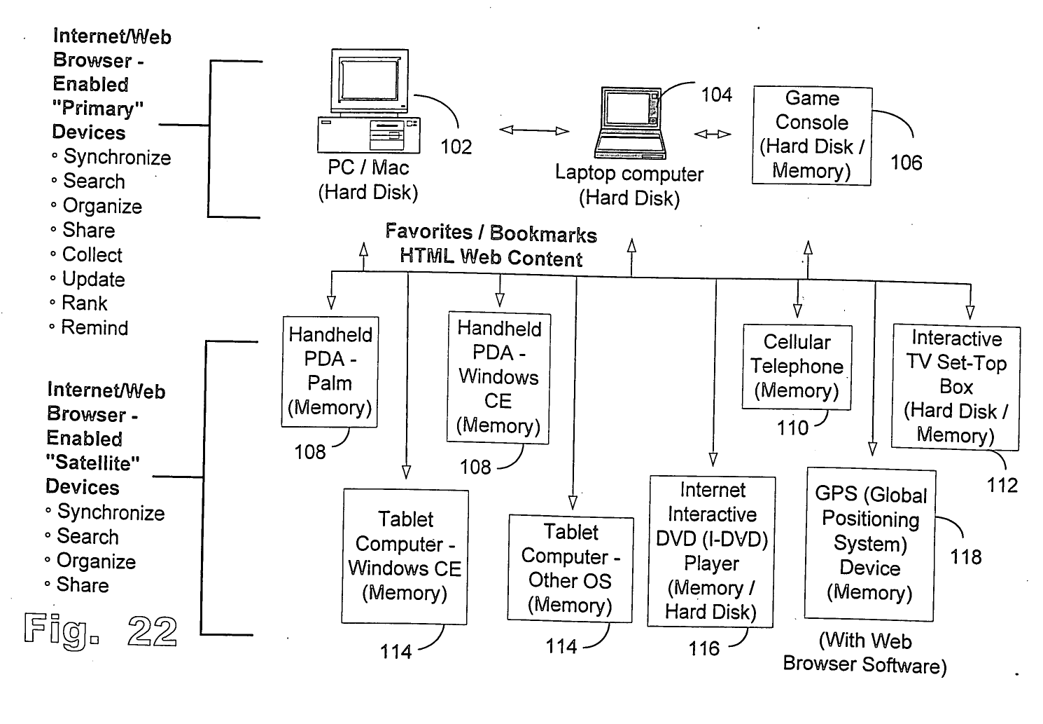

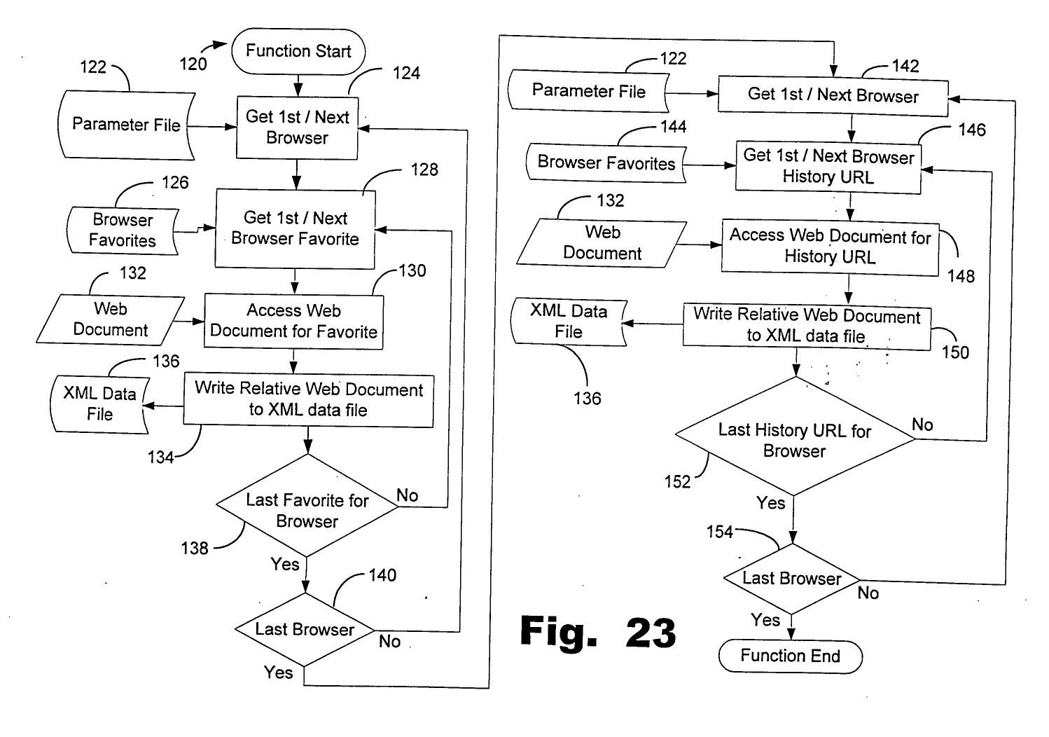

FIG. 22 sets forth an overview of the present invention. A first computer system 102 includes a processor and computer readable memory (a hard disk) for creating and storing a data file. In the preferred embodiment, the data file is an XML data file, which includes (a) a Parameter XML data file record to store the user's parameters as defined through the User Parameter Collection functions; and (b) data file records containing a stored URL and the web document associated with the stored URL. In response to a search query for selecting data file records, as described in Section 1.2.3, the processor creates a stored URL and web document set of the selected data file records.

The first computer system 102 includes a modem, a network card, or a similar devices to link the computer system through various HTTP, HTTPS, shared networks and other links to browser enabled “primary devices” such as a second computer system 104, a game console 106, or browser enabled “satellite” devices, such as a handheld personal display application 108, a cellular telephone 110, an interactive TV Set-Top Box 112, a tablet computer 114, an Internet active DVD player 116, or a global positioning system (GPS) device 118. The first computer system sends the stored URL and web document set as a unit to either a primary device or a satellite device through the link. The primary devices and the satellite devices include software for operating all of the functions of the preferred embodiment. For example, the software enables the devices to perform the search, collect, share, organize, update, rank, synchronize, and remind functions described in Sections 1.2.3 through 1.2.10.

FIG. 23 further illustrates a storing function 120 for storing the contents of the data file. The preferred embodiment accesses a parameter record 122 (the Parameter XML data file record created through the User Parameter Collection functions). In step 124, the present invention accesses the first default browser (designated through function Default Browser 10) and that browser's Favorites stored URL list 126. The first computer system 102 gets that first Favorites stored URL in step 128, and in step 130 accesses the Internet to obtain a web document 132 associated with the stored URL. The web document may contain many different elements in several different formats, including elements in HTML, XML, PDF, GIF, JPEG, and Java formats. In step 134, the first computer system writes the web document to a first XML data file 136. In step 138, the computer system determines whether it has performed steps 128 through 134 for each Favorites stored URL in the browser's Favorites stored URL list, and if not, cycles through those steps until the web document associated with each Favorite stored URL in the Favorites stored URL list has been stored in the first XML data file. In step 140, the computer system determines whether it has performed steps 124 through 134 for each browser listed in the parameter record 122, and if not, cycles through those steps until the web document associated with each Favorite stored URL in the Favorites stored URL list for each browser has been stored in the first XML data file.

The preferred embodiment of the present invention also stores the web document associated with each History stored URL included in the user's browser list. In step 142, the present invention accesses the parameter record 122 to determine the first default browser and accesses that browser's History stored URL list 144. The first computer system 102 gets that first History stored URL in step 146, and in step 148, accesses the web document 132 associated with the stored URL. In step 150, the first computer system writes the web document to the first XML data file 136. In step 152, the computer system determines whether it has performed steps 146 through 150 for each History stored URL in the browser's History stored URL list, and if not, cycles through those steps until the web document associated with each History stored URL in the History stored URL list has been stored in the first XML data file. In step 154, the computer system determines whether it has performed steps 142 through 150 for each browser listed in the parameter record 122, and if not, cycles through those steps until the web document associated with each History stored URL in the History stored URL list for each browser has been stored in the first XML data file.

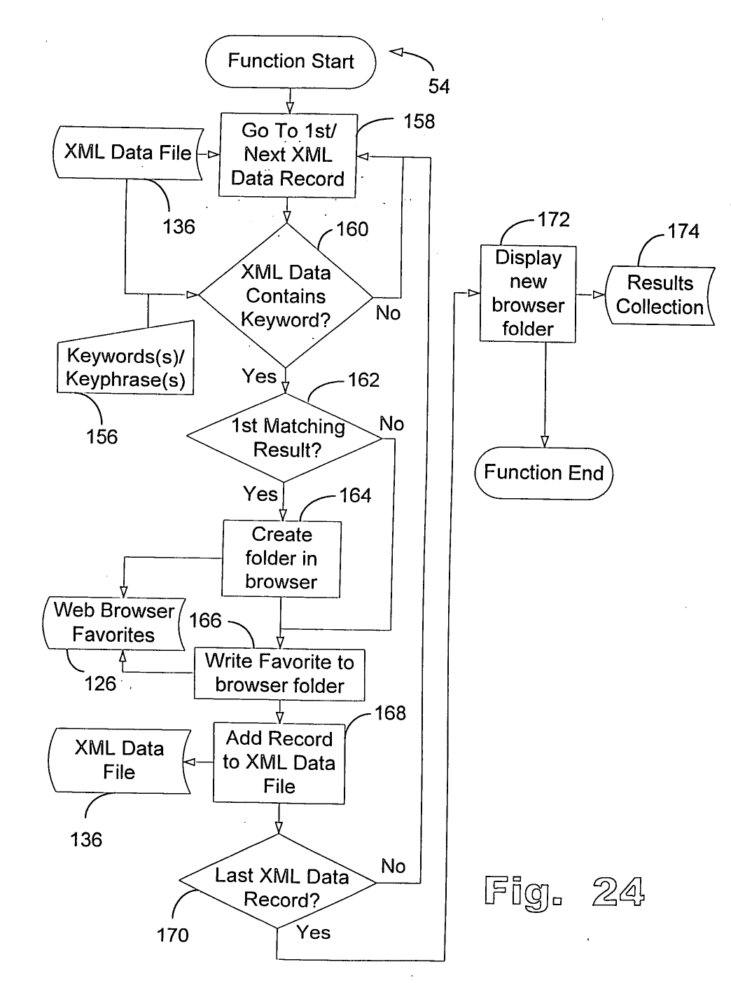

FIG. 24 illustrates the preferred embodiment of the function Search 54 of the present invention. The search function is initiated through function Home Form 28 (FIG. 10), where keywords/keyphrases 156 are entered. The function Search 54 begins with step 158 where the first computer system gets the first data file record of the first XML data file 136. In step 160, the function determines whether the data file record contains the keyword or keyphrase. If the answer is no, the function returns to step 158, and gets the next data file record in the data file. If the data file record does contain the keyword or keyphrase 156, then the function determines in step 162 whether this is the first matching result, and if so, in step 164, the function creates a folder in a user-selected browser, as described in function Organize 66 (FIG. 15). In the example of FIG. 24, a folder is created in the browser's Favorites stored URL list 126, and in step 166, the stored URL for the matching data file record is written to the browser folder. In step 162, if the computer system determines that this is not the first matching result, the computer system goes to step 166, and writes the stored URL for the matching data file record to the browser folder.

In step 168, function Search 54 also marks the data file records in the first XML data file 136 that match the keywords/keyphrases 156. In step 170, the function determines whether the data file record is the last XML data file record in the first XML data file 136. If the answer is no, the function returns to step 158 to examine the next data file record. If the answer is yes, in step 172, a results collection 174 is updated to track the number of times a search has been performed, and the search function displays the results collection (the new browser folder) in the form of FIG. 12.

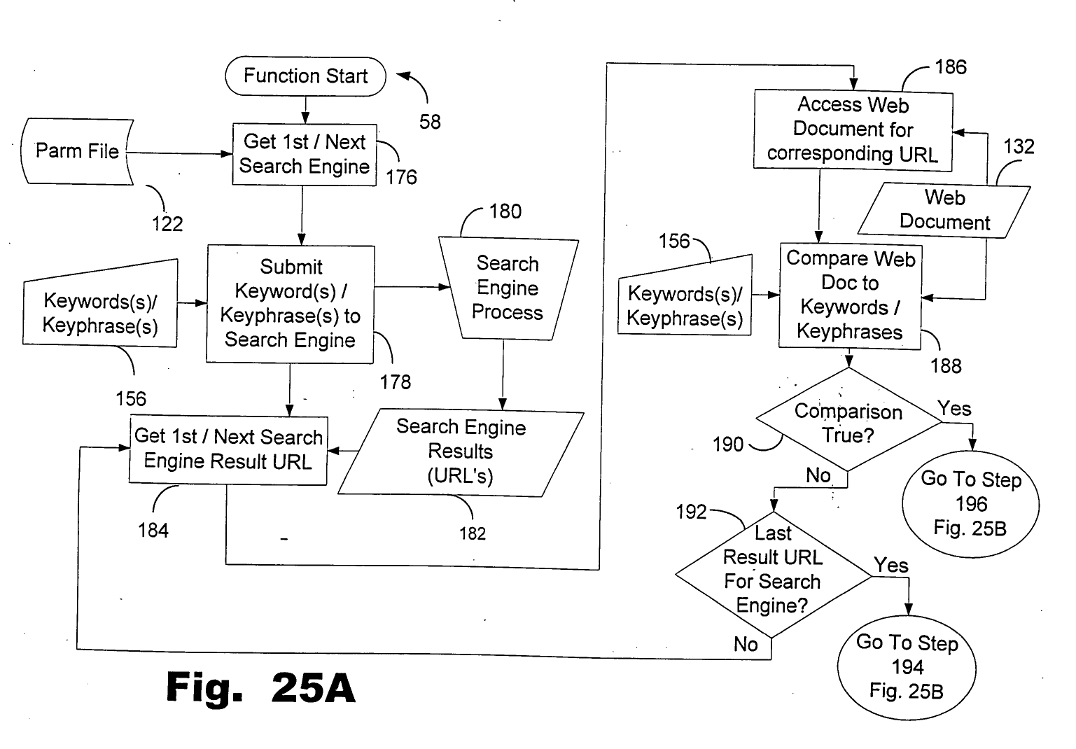

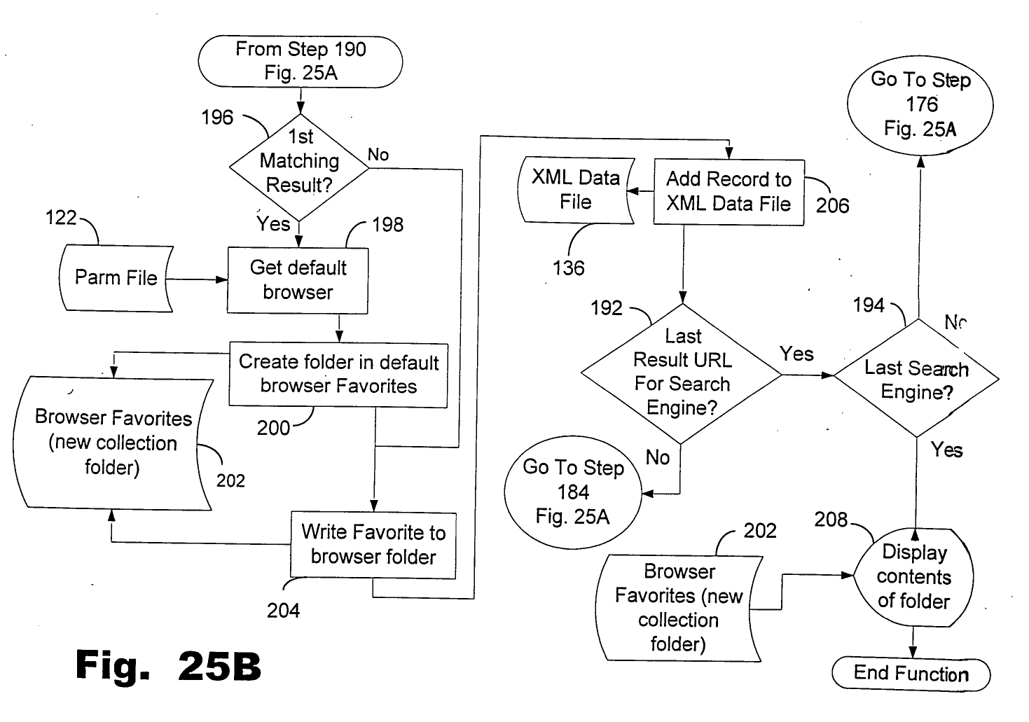

FIG. 25 diagrams the operational details of the preferred embodiment of the function Add New (Collect) 58. The add new (collect) function is initiated through function Home Form 28 (FIG. 10), where keywords/keyphrases 156 are entered. The add new (collect) function begins with step 176 where the first computer system accesses the user-designated list of search engines from the parameter record 122 and gets the first search engine. In step 178, the computer system submits the keywords or keyphrases to the search engine, and the search engine processes the search request in step 180.

Function Add New (Collect) 58 gets the first of a search engine result collection 182 (the URL's that match the search request) in step 184. Next, in step 186, the computer system accesses a web document 132 that corresponds to the first search engine result and, in step 188, compares the web document to the keywords or keyphrases. If, in step 190, the comparison reveals that the web document does not contain the keyword or keyphrase, in step 192, the add new (collect) function determines whether the search result is the last search result of the search engine result collection 182. If the answer is no, the function returns to step 184 to examine the next search engine result. If the answer is yes, in step 194, the computer system determines whether the search engine used is the last user-designated search engine. If the user has designated other search engines, the function returns to step 176 to get the next search engine.

Returning to step 190, if the comparison of the web document to the keywords or keyphrases reveals that the web document does contain the keyword or keyphrase 156, in step 196, function Add New (Collect) 58 determines whether this is the first matching result. If so, in step 198, the function obtains the default browser from the parameter record 122. In step 200, the computer system creates a new collection folder 202 in the browser Favorites for a new results collection. In step 204, the function writes the stored URL for the matching search result to the browser folder. Next, as shown in FIG. 25, in step 206 function Add New (Collect) 58 writes the stored URL and web document (the data file record) to the XML data file 136. The function then goes to step 192 (described above), and determines whether the search result is the last search result of the search engine result collection 182. Once function Add New (Collect) 58 has submitted the keywords or keyphrases to all of the user-designated search engines, in step 208, the function displays the new collection folder 202 in the form shown in FIG. 13.

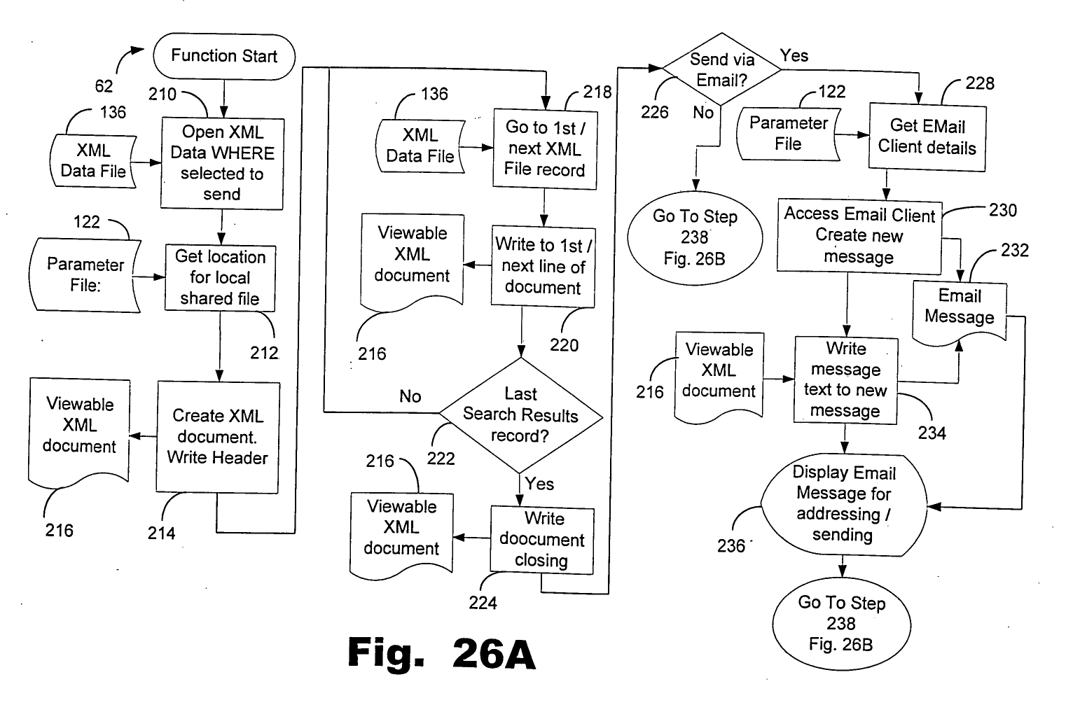

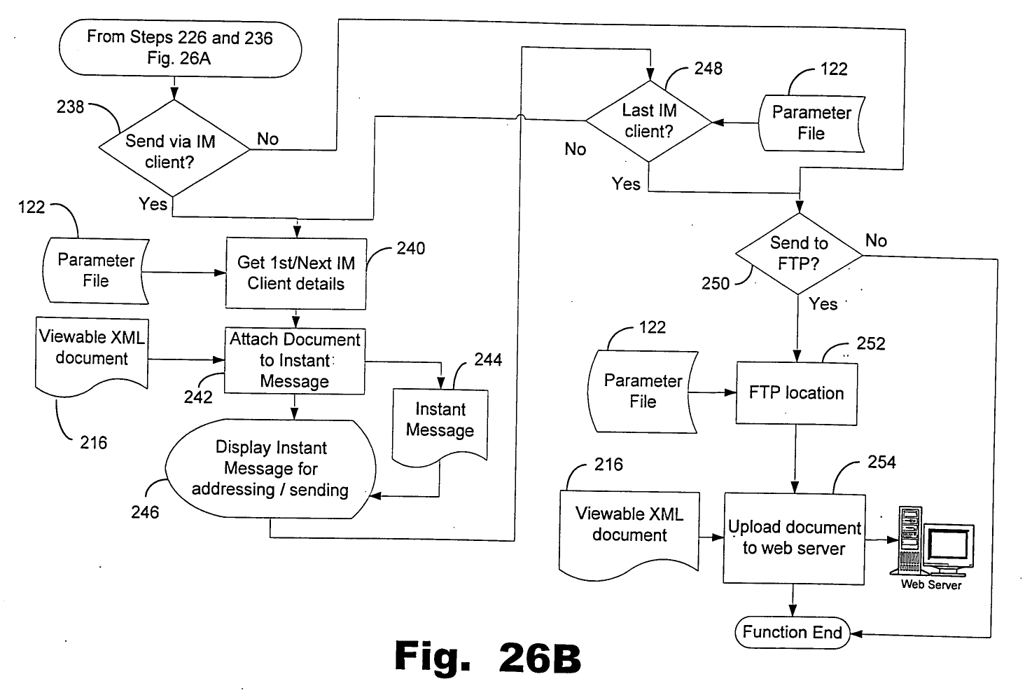

FIG. 26 illustrates the functional details of function Send (Share) 62. This function is initiated from the function Home Form 28 (FIG. 10), function Search 54, function Add New (Collect) 58, or the function OneStep 100. These functions have marked the first XML data file 136 to designate the selected stored URLs and associated web pages. In step 210, the send function opens the first XML data file where the data file records have been marked and, in step 212, gets the location for the local share file from the parameter record 122. In step 214, the computer system creates a viewable XML document 216 and writes a header to the document to indicate the start of the document. In step 218, the send function goes to the first marked data file record of the first XML data file, and in step 220 writes that record as the next line in the viewable XML document. In step 222, the send function determines whether the data file record is the last marked data file record in the first XML data file. If the answer is no, the send function returns to step 218 to cycle through all of the marked data file records in the first XML data file. Once all the marked data file records in the first XML data file have been written to the viewable XML document, in step 224, the computer system writes a document closing to the viewable XML document to indicate the end of the document.

In step 226, function Send (Share) 62 examines the user's selections as entered in the form shown in FIG. 14 and determines whether the selected web pages, in the form of the viewable XML document 216, is to be sent via email. If the answer is yes, the send function gets the email client details in step 228 from the parameter record 122. Next, in step 230, the computer system accesses the email client and creates a new email message 232. In step 234, the search function writes the viewable XML document to the new email message. Finally, in step 236, the computer system displays the email message to the user for addressing and sending.

If, in step 226, function Send (Share) 62 determined that the viewable XML document 216 is not to be sent via email, or the send function has reached step 236, then, in step 238, the send function examines the user's selections from FIG. 14 and determines whether the viewable XML document 216 is to be sent via an instant messenger. If the answer is no, the computer system goes to step 250 (below). If the answer is yes, in step 240, the send function gets the details for the first user-designated instant messenger from the parameter record 122. In step 242, the computer system attaches the viewable XML document to an instant message 244. In step 246, the instant message is displayed for addressing and sending. Next, in step 248, the send function checks the parameter record to determine whether the viewable XML document has been sent to all user-designated instant messengers. If the answer is no, the computer system returns to step 240 to cycle through all instant messengers. Otherwise, the send function turns to file transfer protocol functions (FTP).

In step 250 of FIG. 26, the send function examines the user's selections from FIG. 14 and determines whether the viewable XML document 216 is to be sent via file transfer protocol. If the answer is no, the function is completed. If the answer is yes, in step 252, the send function obtains the location where the viewable XML document is to be transferred from the parameter record 122. Then, in step 254, the computer system uploads the viewable XML document to a web server at the designated location.

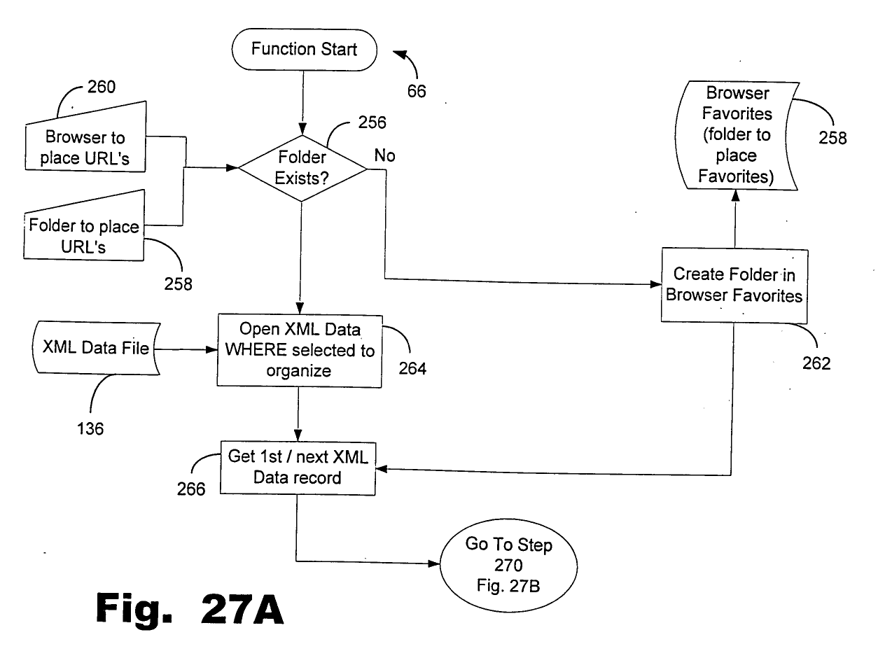

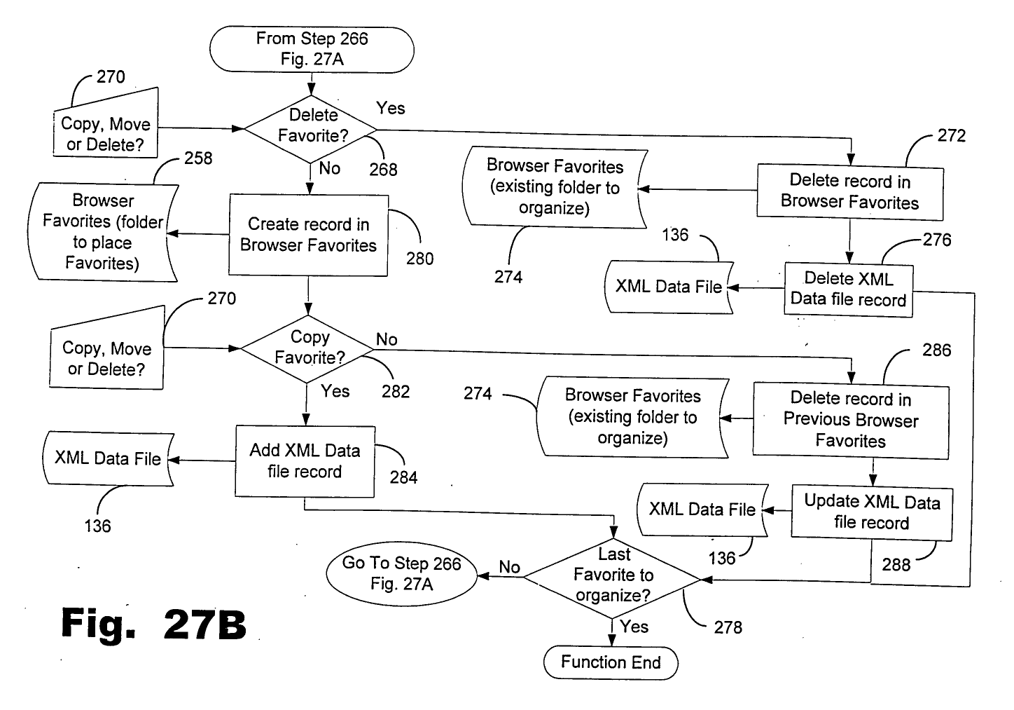

FIG. 27 illustrates the details of function Organize 66, which is activated from the function Home Form 28 (FIG. 10) to provide the user with options to organize a set of stored URLs associated with the marked data file records (the data file records matching the user-designated keywords/keyphrases). The organize function begins by examining the user's selections in FIG. 15 regarding a designated browser and browser folder for organizing the matching data file records. In step 256, the computer system determines whether a user-designated destination browser folder 258 exists in a user-designated browser 260. If the answer is no, in step 262, the organize function creates a new browser folder 258 in the browser Favorites. In step 264, the organize function opens the first XML data file 136 where the data file records have been marked, and in step 266 gets the first marked data file record. In step 268, the computer system examines the user's selections 270 from FIG. 15, and determines whether the user has designated that the marked data file records will be deleted. If the answer is yes, in step 272, the stored URL corresponding to the current marked data file record is deleted from the corresponding browser folder 274, and, in step 276, the current data file record is deleted from the first XML data file 136. Then, in step 278, the organize function determines whether the current marked data file record is the last marked data file record in the first XML data file. If the answer is yes, the function ends. Otherwise, the computer system returns to step 266 to cycle through the remaining marked data file records.

If, in step 268, the user has not indicated that the marked data file records from the first XML data file 136 will be deleted, in step 280, the function Organize 66 creates a stored URL corresponding to the current marked data file record in the user-designated browser folder 258. In step 282, the computer system examines the user's selections 270 from FIG. 15, and determines whether the user has designated that the marked data file records will be copied. If the answer is yes, in step 284, the organize function adds a new data file record in the first XML data file 136 indicating that the user-designated browser folder 258 is associated with the current marked data file record. If, in step 282, the organize function determines that the marked data file records are to be moved (not copied), in step 286, the stored URL corresponding to the current marked data file record is deleted from the corresponding browser folder 274, and, in step 288, the current marked data file record in the first XML data file is updated to reflect that the data file record is associated with the user-designated browser folder 258. From steps 284 and 288, the computer system goes to step 278, to determine whether the current marked data file record is the last marked data file record in the first XML data file. If the answer is yes, the function ends. Otherwise, the computer system returns to step 266 to cycle through the remaining marked data file records.

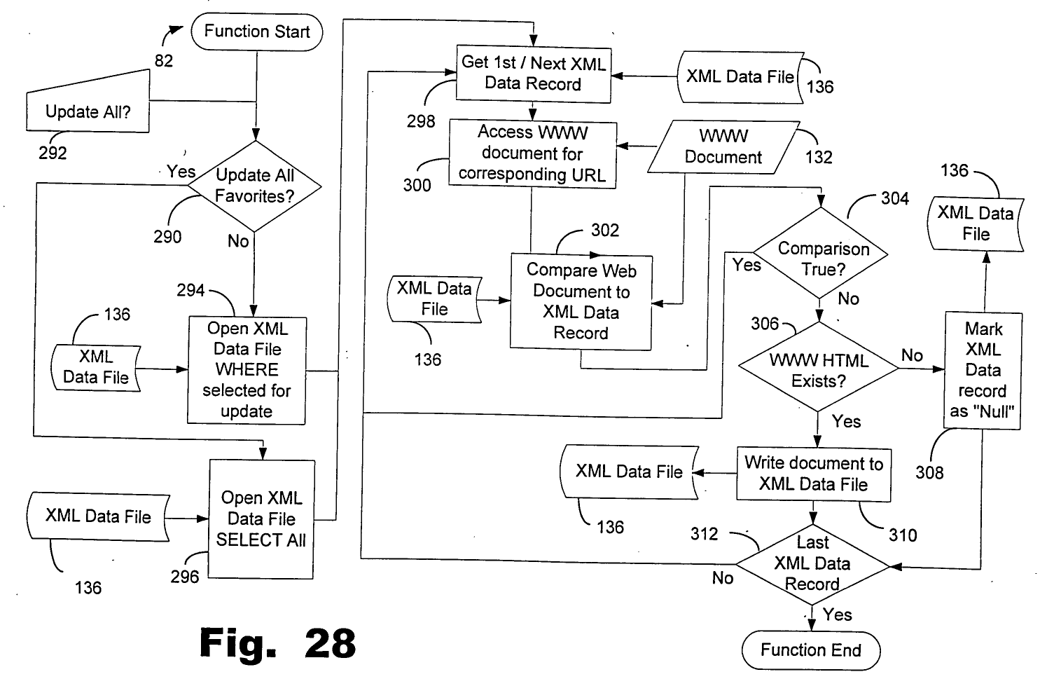

FIG. 28 illustrates the functional details of function Update 82, which is activated from either function Home Form 28 (FIG. 10) or function Search 54, which may mark certain data file records for updating. In step 290, the computer system examines the user's selections 292 from FIG. 16, and determines whether the user has indicated that all the user's Favorites stored URLs will be updated. If the answer is no, in step 294, the update function opens the first XML data file 136 where the data file records have been marked. Otherwise, in step 296, the update function opens the entire first XML data file.

In step 298, function Update 82 gets the first open data file record from the first XML data file 136. In step 300, the update function accesses the Internet to obtain the web document 132 associated with the URL from the current data file record. In step 302, the computer system compares the web document from the Internet with the web document associated with the current data file record from the first XML data file. If the update function determines in step 304 that the web documents are the same, the function returns to step 298 and gets the next open data file record.

In FIG. 28, if function Update 82 determines in step 304 that the web documents are not the same, in step 306, the function determines whether a web document exists on the Internet for the URL for the current data file record. If the answer is no, in step 308, the computer system marks the current data file record in the first XML data file 136 as “null.” If the answer is yes, in step 310, the update function writes the Internet web document 132 to the current data file record in the first XML data file. In step 312, the update function determines whether the current data file record is the last open data file record. If the answer is yes, the function ends. Otherwise, the update returns to step 298 and gets the next open data file record.

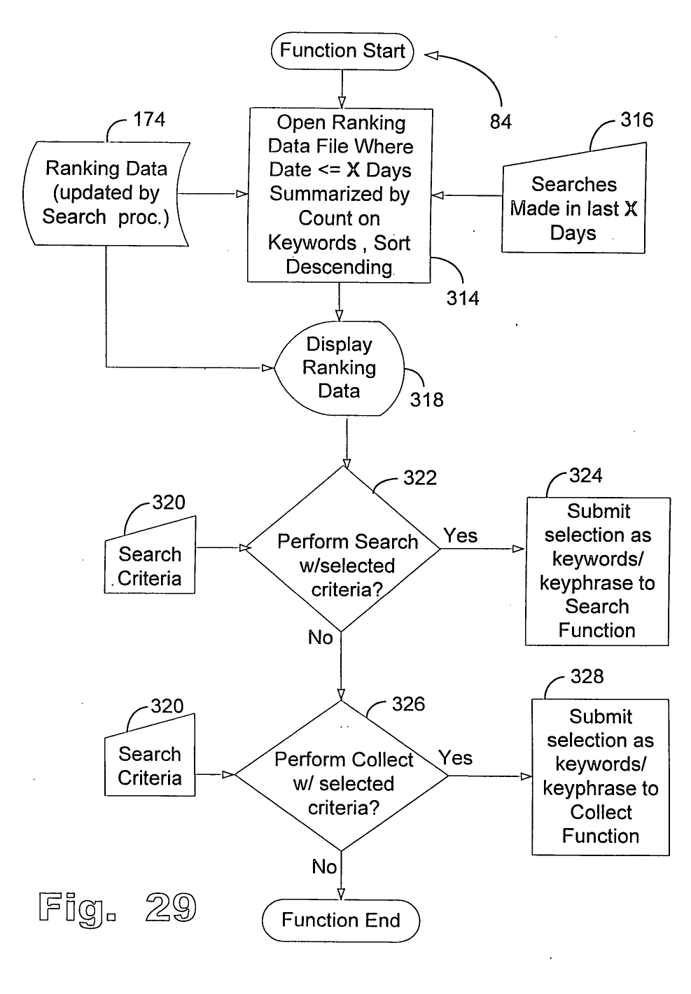

FIG. 29 is a functional diagram of function Rank 84. The rank function begins in step 314 by opening the results collection 174 updated by function Search 54, and by examining the user's time period selection 316 from FIG. 17 to determine the selected time period (i.e., the last 30 days) for which searches will be displayed. In step 318, the rank function displays search criteria 320 (query parameters) that have been searched within the selected time period and the number of times the search criteria have been searched.

Once the search criteria 320 and ranking results 174 are displayed, the user may select a search criteria from the list and click on “Search Favorites” or “Collect Favorites,” as shown in FIG. 17. Returning to FIG. 29, in step 322, function Rank 84 then determines whether the user has clicked on “Search Favorites.” If the answer is yes, in step 324, the function submits the search criteria to function Search 54. If the answer is no, in step 326, the rank function determines whether the user has clicked on “Collect Favorites.” If the answer to that inquiry is yes, in step 328, the function submits the search criteria to function Add New (Collect) 58.

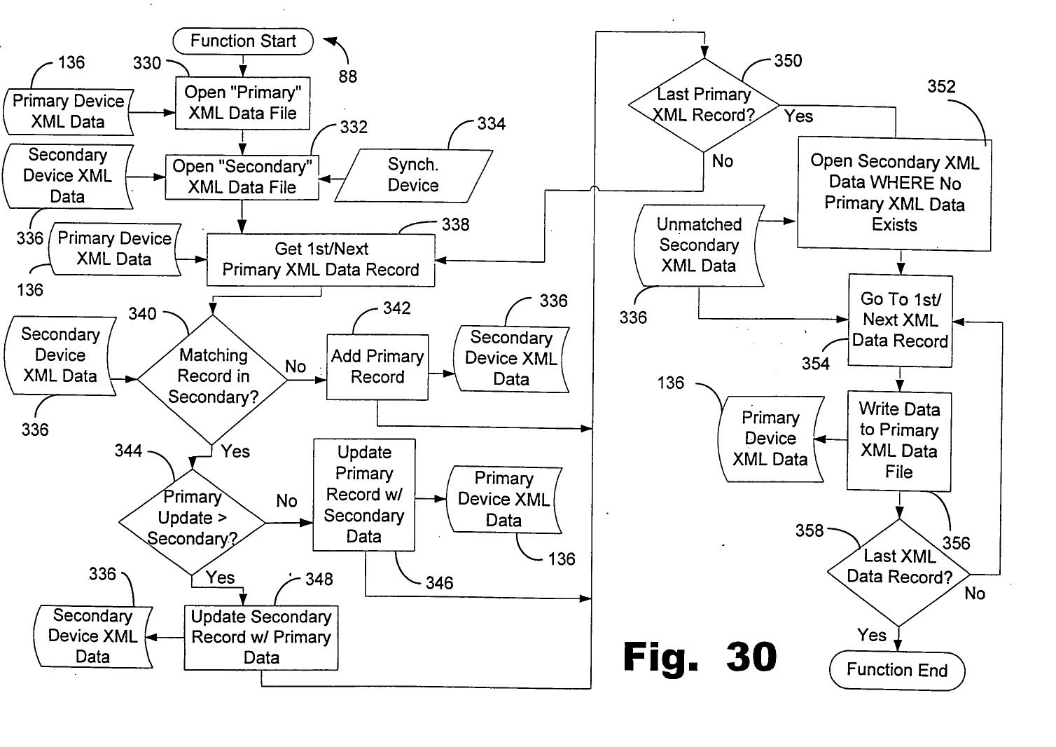

FIG. 30 illustrates the operational details of function Synchronize 88, which may be selected from function Home Form 28 (FIG. 10). The synchronize function permits the user to select the devices with which Favorites stored URLs and document data will be coordinated. The function begins in step 330 by opening the first XML data file 136. In step 332, the computer system accesses the parameter information collected through function Synchronization Devices 24, and obtains the synchronization device details 334 related to the synchronization device or devices selected in FIG. 18. In step 332, the synchronization function also opens a second XML data file 336 located in the selected synchronization device.

In step 338, the synchronization function gets the first data file record from the first XML data file 136. In step 340, the computer system compares the selected data file record with the data file records in the second XML data file 336 to determine whether there is a matching data file record. If the answer is no, in step 342, the selected data file record is added to the second XML data file. If the answer is yes, function Synchronize 88 compares the selected data file record with the matching data file record from the second XML data file, and, in step 344, determines whether the selected data file record has been updated more recently than the matching data file record. If the answer is no, in step 346, the synchronization function replaces the selected data file record in the first XML data file with the matching data file record from the second XML data file. If the selected data file record has been updated more recently than the matching data file record, then, in step 348, the function replaces the matching data file record in the second XML data file with the selected record from the first XML data file.

Once the most current data file record is included in both the first XML data file 136 and the second XML data file 336, function Synchronize 88 determines in step 350 whether the selected data file record is the last data file record in the first XML data file. If the answer is no, the function returns to step 338 to assign the next data file record as the selected data file record. Once all the data file records in the first XML data file have been processed, the synchronization function processes data file records in the second XML data file that are not in the first XML data file. In step 352, the computer system opens the data file records in the second XML data file 336 that are not contained in the first XML data file. In step 354, the synchronization function gets the first open data file record (from the second XML data file) and, in step 356, writes the selected data file record to the first XML data file. In step 358, the synchronization function determines whether the selected data file record is the last open data file record. If the answer is no, the function returns to step 354 so as to copy all of the open data file records from the second XML data file to the first XML data file. Once the last open data file record has been copied, the synchronization function ends.

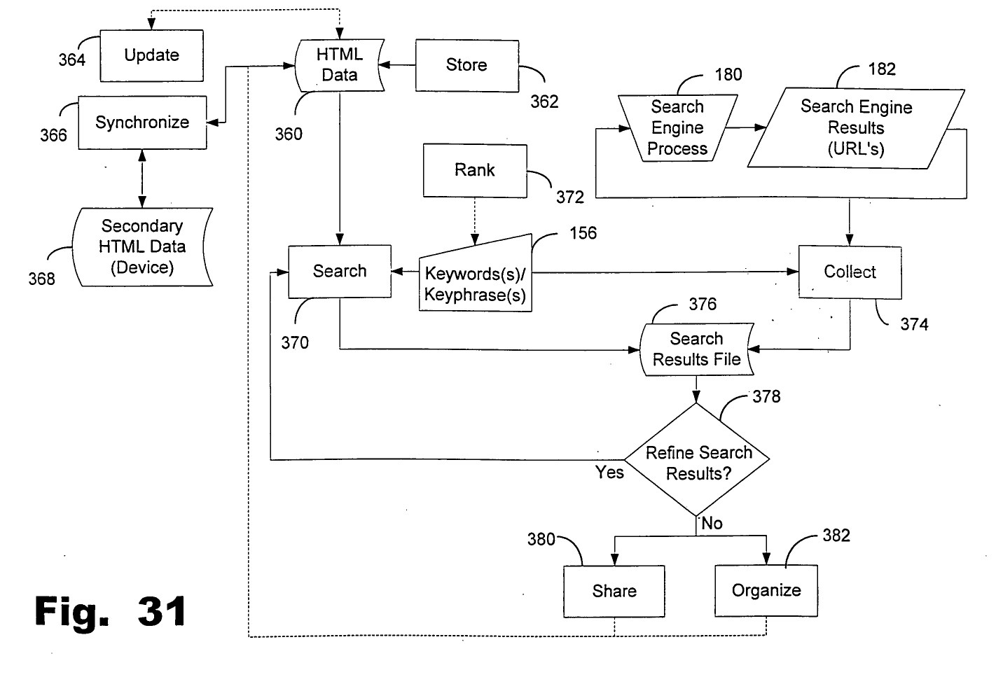

FIG. 31 shows an overview of the method of function OneStep 100, also described with reference to FIG. 21. The OneStep function allows the user to perform many of the functions described above from a single form. The OneStep function is activated through the function Home Form 28 (FIG. 10), which includes a section for the user to designate the keywords or keyphrases 156 for searching. A first HTML data file 360 (an alternative embodiment to the XML data file described with regard to other functions) corresponding to the search criteria is stored in step 362 in accordance with store function 120 illustrated by FIG. 23. The first HTML data file is updated (made current) in step 364 through use of function Update 82, or may be synchronized in step 366 with a second HTML data file 368 from a user-designated secondary device in accordance with function Synchronize 88.

Next, in step 370, function Search 54 is performed on the keywords or keyphrases 156 to find matches within the first HTML data file 360. In step 372, function Rank 84 tracks the number of times a search has been performed on that search criteria. The keywords or keyphrases are also submitted in step 374 to function Add New (Collect) 58, where the computer system submits the keywords or keyphrases to user-designated search engines, and the search engines processes the search request in step 180. The add new (collect) function returns the results of step 180 in the search engine result collection 182 (the URL's that match the search request). The results of operation of function Search 54 and function Add New (Collect) 58 are placed in a search results file 376. In step 378, the search results may be refined, and resubmitted to the search function (step 370) and the add new (collect) function (step 374). Once the search results are finalized, they may be shared in step 380 in accordance with function Send (Share) 62 or organized, in step 382, in accordance with function Organize 66. Alternatively, the search results may be synchronized in step 366 in accordance with function Synchronize 88.

While various embodiments of the present invention have been described above, it should be understood that they have been presented by way of example only, and not limitation. It will be understood by those skilled in the art that various changes in form and details may be made therein without departing from the spirit and scope of the invention as defined in the appended claims. For example, while reference is made to a “computer” and a “first computer,” those terms are not limited to standard desktop computers, but encompass all browser enabled devices, such as servers, clients, game consoles, handheld personal display application, a cellular telephone, interactive TV Set-Top Boxes, tablet computers, Internet-active DVD players, and GPS devices. Further, while reference is made to HTML content and meta-data, the term web document encompasses all elements of a web page. In addition, the present invention may be embedded in software, pre-installed hardware, microchips, and any other memory devices. Thus, the breadth and scope of the present invention should not be limited by any of the above-described exemplary embodiments, but should be defined only in accordance with the following claims and their equivalents.

I claim:

1. A method for distributing a stored URL and an XML document related to the stored URL, comprising the steps of:
(1) parsing a web document of a first URL to obtain XML elements;
(2) writing a first XML data file from said XML elements and the first URL;
(3) storing the first XML data file on a first computer system;
(4) repeating steps 1 through 3 for at least one additional URL to generate a plurality of XML data files;
(5) searching the plurality of XML data files for a search criteria;
(6) creating a matching result data file containing at least one XML data file when at least one matching result is obtained from said searching; and
(7) sending the matching result data file to a second computer system.

2. The method of claim 1 wherein the first XML data file contains XML elements that are not metadata.

3. The method of claim 1 wherein the first XML data file also contains a web document associated with the first URL.

4. The method of claim 1 wherein the search criteria is comprised of a key word or a key phrase.

5. The method of claim 1 wherein the first URL and the at least one additional URL are comprised from a favorites list.

6. The method of claim 1 wherein the first URL and the at least one additional URL are comprised from a history list.

7. A computer program product in a computer readable memory for distributing a stored URL and an XML document related to the stored URL, comprising:
means for parsing a plurality of web documents from a plurality of URLs to obtain XML elements from each of the plurality of URLs;
means for writing a plurality of XML data files from the plurality of web documents and the plurality of URLs, each of said XML data files being written from a given set of XML elements from a given URL and the given URL;
means for storing the plurality of XML data files on a first computer system;
means for searching the plurality of XML data files for a search criteria;
means for creating a matching result data file containing at least one XML data file when at least one matching result is obtained from said searching; and
means for sending the matching result data file to a second computer system.

8. The computer program product of claim 7 wherein each of the plurality of XML data files contains XML elements that are not metadata.

9. The computer program product of claim 8 wherein each of the plurality of XML data files also contains the web document associated with its given URL.

10. The computer program product of claim 8 wherein the search criteria is comprised of a key word or a key phrase.

11. The computer program product of claim 8 wherein the plurality of URLs is comprised from a favorites list.

12. The computer program product of claim 8 wherein the plurality of URLs is comprised from a history list.

13. A system for distributing a stored URL and web document set comprising:
means for parsing a plurality of web documents from a plurality of URLs to obtain XML elements from each of the plurality of URLs;
means for writing a plurality of XML data files from the plurality of web documents and the plurality of URLs, each of said XML data files being written from a given set of XML elements from a given URL and the given URL;
means for storing the plurality of XML data files on a first computer system;
means for searching the plurality of XML data files for a search criteria;
means for creating a matching result data file containing at least one XML data file when at least one matching result is obtained from said searching; and
means for sending the matching result data file to a second computer system.

14. The system claim 13 wherein each of the plurality of XML data files contains XML elements that are not metadata.

15. The system claim 166 wherein each of the plurality of XML data files also contains the web document associated with its given URL.

16. The system claim 13 wherein the search criteria is comprised of a key word or a key phrase.

17. The system claim 13 wherein the plurality of URLs is comprised from a favorites list.

18. The system claim 13 wherein the plurality of URLs is comprised from a history list.
